(19) United States
(12) Patent Application Publication
(10) Pub. No.: US 2026/0296664 A1
(43) Pub. Date: Oct. 1, 2026

(54) ACTUATABLE AIRFLOW SPLITTER FOR AIRCRAFT PROPULSION SYSTEM

(71) Applicant: RTX Corporation, Farmington, CT (US)

(72) Inventors: Daniel B. Kupratis, Wallingford, CT (US); Konstantinos P. Giannakopoulos, Middletown, CT (US); Murat Yazici, Glastonbury, CT (US); Sean P R Nolan, Wethersfield, CT (US); Jeffrey T. Morton, Manchester, CT (US); Thomas E. Clark, Wells, ME (US)

(21) Appl. No.: 19/089,926

(22) Filed: Mar. 25, 2025

(51) Int. Cl. B64D 33/02; F02K 3/075

(52) U.S. Cl. CPC B64D 33/02; F02C 9/20; F02K 3/075; B64D 2033/0233

(57) ABSTRACT

An aircraft propulsion system assembly includes a fan rotor, an inner flowpath, an outer flowpath and an inter-flowpath structure. The fan rotor includes a plurality of fan blades arranged circumferentially about an axis. The outer flowpath includes an outer flowpath inlet downstream of the fan rotor. The outer flowpath inlet is radially outboard of the inner flowpath inlet. The inter-flowpath structure is disposed radially between and partially forms the inner flowpath inlet and the outer flowpath inlet. The inter-flowpath structure includes a splitter and an actuator. The splitter forms a leading edge of the inter-flowpath structure. The actuator is configured to translate the splitter axially along the axis between a first position and a second position.

### BACKGROUND OF THE DISCLOSURE

### 1. Technical Field

This disclosure relates generally to an aircraft propulsion system and, more particularly, to flow splitting for the aircraft propulsion system.

### 2. Background Information

A turbofan engine for an aircraft propulsion system includes a splitter for splitting incoming air into a core flowpath and a bypass flowpath. Various turbofan engine arrangements are known in the art for tailoring the splitting of the incoming air into the core flowpath and the bypass flowpath. While these known turbofan engine arrangements have various benefits, there is still room in the art for improvement.

### SUMMARY OF THE DISCLOSURE

According to an aspect of the present disclosure, an assembly is provided for an aircraft propulsion system. This assembly includes a fan rotor, an inner flowpath, an outer flowpath and an inter-flowpath structure. The fan rotor includes a plurality of fan blades arranged circumferentially about an axis. The fan blades include a first fan blade. The first fan blade includes a first chord length. The inner flowpath includes an inner flowpath inlet downstream of the fan rotor. The outer flowpath includes an outer flowpath inlet downstream of the fan rotor. The outer flowpath inlet is radially outboard of the inner flowpath inlet. The inter-flowpath structure is disposed radially between and partially forms the inner flowpath inlet and the outer flowpath inlet. The inter-flowpath structure includes a splitter and an actuator. The splitter forms a leading edge of the inter-flowpath structure. The actuator is configured to translate the splitter axially along the axis between a first position and a second position. The leading edge of the inter-flowpath structure is disposed a first distance along the axis from the first fan blade when the splitter is in the first position. The leading edge of the inter-flowpath structure is disposed a second distance along the axis from the first fan blade when the splitter is in the second position. The second distance is greater than the first distance. The second distance is equal to or less than one and one-half times the first chord length.

According to another aspect of the present disclosure, another assembly is provided for an aircraft propulsion system. This assembly includes a fan rotor, an inner flowpath, an outer flowpath and an inter-flowpath structure. The fan rotor includes a platform surface and a plurality of fan blades arranged circumferentially about an axis. The fan blades include a first fan blade. The first fan blade includes a spanwise height that extends spanwise along a span line of the first fan blade from the platform surface to a tip of the first fan blade. A reference point is disposed a spanwise distance from the platform surface along the span line. The spanwise distance is equal to or greater than one-tenth of the spanwise height. The inner flowpath includes an inner flowpath inlet next to and downstream of the fan rotor. The outer flowpath includes an outer flowpath inlet next to and downstream of the fan rotor. The outer flowpath inlet is radially outboard of the inner flowpath inlet. The inter-flowpath structure is disposed radially between and partially forms the inner flowpath inlet and the outer flowpath inlet. The inter-flowpath structure includes a splitter and an actuator. The splitter forms a leading edge of the inter-flowpath structure that is radially aligned with the reference point. The actuator is configured to move the splitter axially along the axis between a first position and a second position. The leading edge of the inter-flowpath structure is disposed a first distance along the axis from the first fan blade when the splitter is in the first position. The leading edge of the inter-flowpath structure is disposed a second distance along the axis from the first fan blade when the splitter is in the second position. The second distance is greater than the first distance.

According to still another aspect of the present disclosure, another assembly is provided for an aircraft propulsion system. This assembly includes a fan rotor, an inner flowpath, an outer flowpath, an inter-flowpath structure and a controller. The fan rotor includes a plurality of fan blades arranged circumferentially about an axis. The fan blades include a first fan blade. The inner flowpath includes an inner flowpath inlet next to and downstream of the fan rotor. The outer flowpath includes an outer flowpath inlet next to and downstream of the fan rotor. The outer flowpath inlet is radially outboard of the inner flowpath inlet. The inter-flowpath structure is disposed radially between and partially forms the inner flowpath inlet and the outer flowpath inlet. The inter-flowpath structure includes a splitter and an actuator. The splitter forms a leading edge of the inter-flowpath structure. The actuator is configured to move the splitter axially along the axis between a first position and a second position. The leading edge of the inter-flowpath structure is disposed a first distance along the axis from the first fan blade when the splitter is in the first position. The leading edge of the inter-flowpath structure is disposed a second distance along the axis from the first fan blade when the splitter is in the second position. The second distance is greater than the first distance. The controller is configured to control operation of the actuator to move the splitter back and forth along the axis based on at least one of a rotational speed of the fan rotor or an air temperature.

The spanwise distance may be between two-tenths of the spanwise height and one-half of the spanwise height.

The assembly may also include a controller configured to control operation of the actuator to periodically and/or continuously move the splitter back and forth along the axis based on a rotational speed of the fan rotor.

The assembly may also include a controller configured to control operation of the actuator to periodically and/or continuously move the splitter back and forth along the axis based on an air temperature.

The second distance may be equal to or less than the first chord length.

The second distance may be equal to or less than three-fourths of the first chord length.

The first distance may be equal to or greater than one-fourth of the second distance.

The first distance may be equal to or greater than one-third of the second distance.

The splitter may extend circumferentially about the axis.

The splitter may be configured as or otherwise include an annular splitter.

The fan rotor may include a platform surface. The first fan blade may also include a spanwise height that extends spanwise along a span line of the first fan blade from the platform surface to a tip of the first fan blade. A reference point may be disposed a spanwise distance from the platform surface along the span line. The spanwise distance may be equal to or greater than one-tenth of the spanwise height. The reference point may be radially aligned with the leading edge of the inter-flowpath structure.

The spanwise distance may be equal to or greater than two-tenths of the spanwise height.

The spanwise distance may be equal to or less than one-half of the spanwise height.

The assembly may also include a controller configured to control operation of the actuator to translate the splitter when a rotational speed of the fan rotor is equal to or less than a threshold.

The assembly may also include a controller configured to control operation of the actuator to translate the splitter when an air temperature is equal to or less than a threshold.

The assembly may also include an engine core. The engine core may include a compressor section, a combustor section and a turbine section. The inner flowpath may extend through the compressor section, the combustor section and the turbine section from the inner flowpath inlet to an inner flowpath exhaust. The outer flowpath may bypass the engine core.

The assembly may also include a bladed turbine rotor disposed in the turbine section. The bladed turbine rotor may be operably coupled to and configured to drive rotation of the fan rotor about the axis.

The assembly may also include a compressor rotor coupled to and rotatable with the fan rotor. The inner flowpath may extend across the compressor rotor.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic illustration of an aircraft propulsion system.

FIGS. 2A and 2B are schematic illustrations of a portion of the aircraft propulsion system with an airflow splitter in various positions.

FIG. 3 is a schematic cross-sectional illustration of a fan blade.

FIGS. 4A and 4B are partial schematic illustrations of the airflow splitter with various geometries.

### DETAILED DESCRIPTION

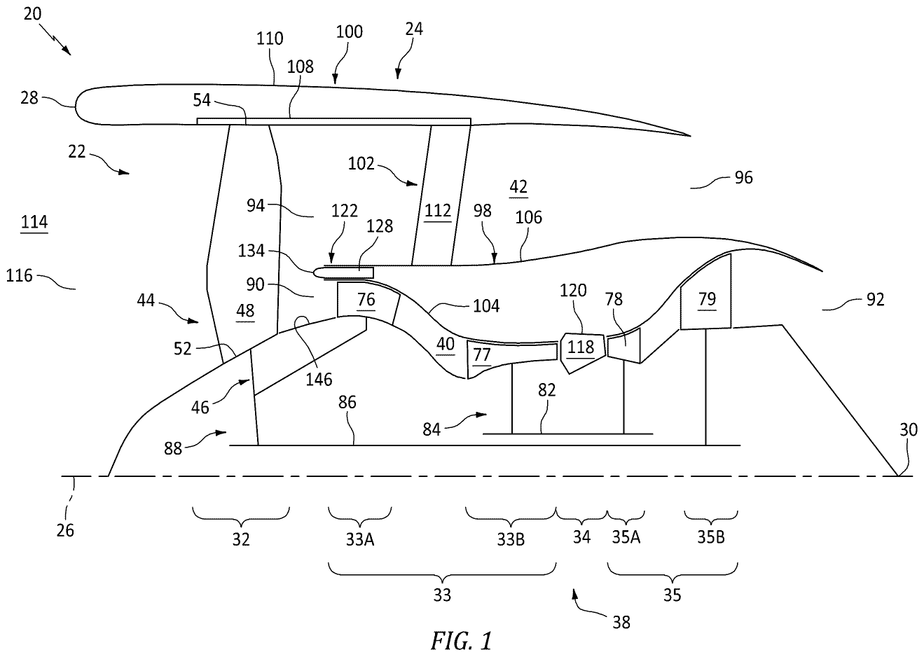

FIG. 1 illustrates a propulsion system 20 for an aircraft. The aircraft may be an airplane, a drone (e.g., an unmanned aerial vehicle (UAV)), or any other manned or unmanned aerial vehicle or system. The aircraft propulsion system 20 of FIG. 1 includes a gas turbine engine 22 (e.g., a turbofan engine) housed within a stationary housing structure 24. The aircraft propulsion system 20 extends axially along an axis 26 between an axial upstream, forward end 28 of the aircraft propulsion system 20 and an axial downstream, aft end 30 of the aircraft propulsion system 20. Briefly, the propulsion system axis 26 may be a centerline axis of the aircraft propulsion system 20, the turbine engine 22, the housing structure 24 and/or one or more of members of the turbine engine 22 and/or the housing structure 24. The propulsion system axis 26 may also or alternatively be a rotational axis for one or more members of the turbine engine 22.

The aircraft propulsion system 20 and its turbine engine 22 of FIG. 1 include a fan section 32, a compressor section 33, a combustor section 34 and a turbine section 35. The compressor section 33 of FIG. 1 includes a low pressure compressor (LPC) section 33A and a high pressure compressor (HPC) section 33B. The turbine section 35 of FIG. 1 includes a high pressure turbine (HPT) section 35A and a low pressure turbine (LPT) section 35B. At least (or only) the LPC section 33A, the HPC section 33B, the combustor section 34, the HPT section 35A and the LPT section 35B collectively form a core 38 of the turbine engine 22. The aircraft propulsion system 20 and its turbine engine 22 of FIG. 1 also include an inner core flowpath 40 (e.g., an annular core flowpath) and an outer bypass flowpath 42 (e.g., an annular bypass flowpath).

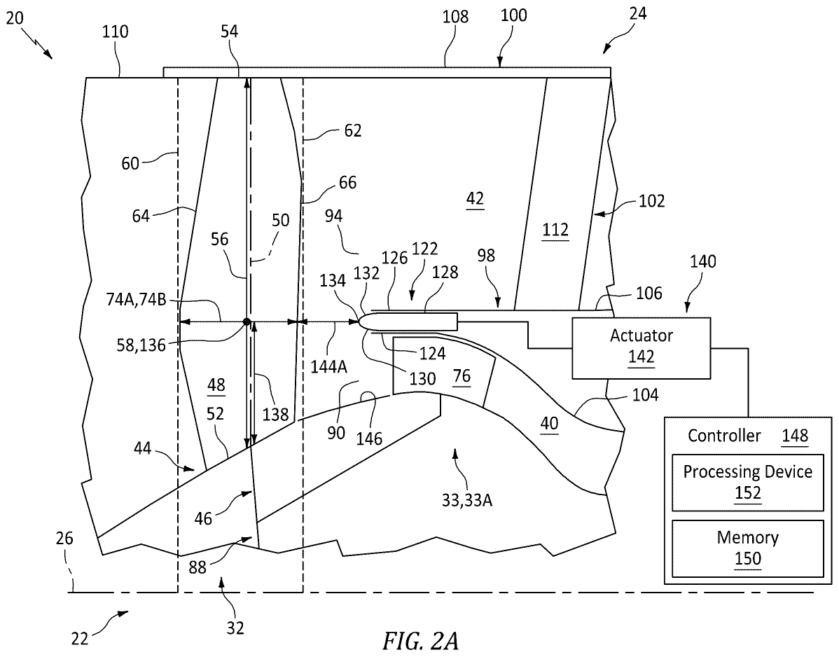

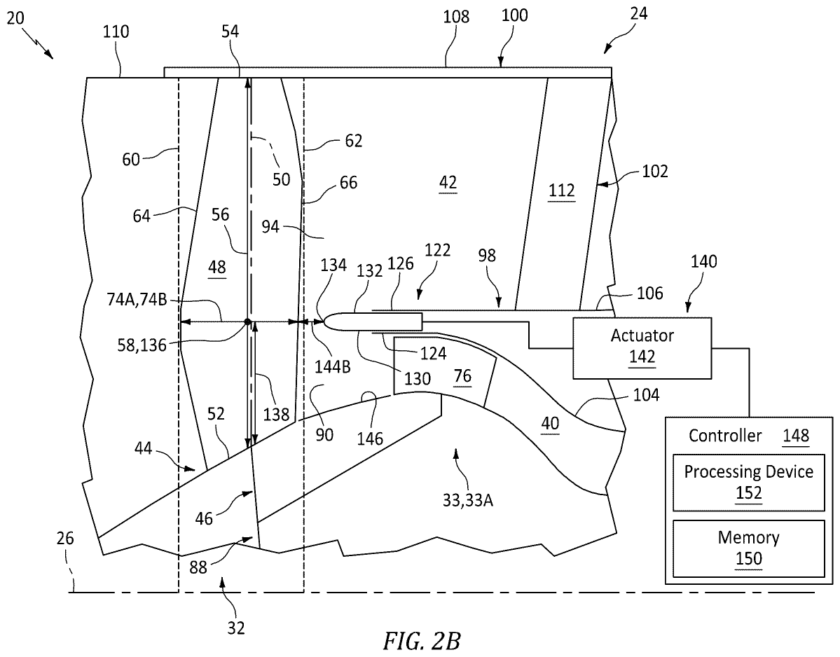

Referring to FIGS. 2A and 2B, the fan section 32 includes a bladed fan rotor 44. This fan rotor 44 includes a rotor base 46 (e.g., a disk or a hub) and a plurality of fan blades 48 (e.g., airfoils). The fan blades 48 are arranged and may be equispaced circumferentially about the rotor base 46 and the propulsion system axis 26 in an array; e.g., an annular array. The fan blades 48 are connected to (e.g., formed integral with or otherwise attached to) the rotor base 46. Each of the fan blades 48 projects spanwise along a span line 50 of the respective fan blade 48 (e.g., radially relative to the propulsion system axis 26) out from an inner platform surface 52 of the fan rotor 44 to a distal tip 54 of the respective fan blade 48. Each fan blade 48 thereby has a spanwise height 56 (e.g., a radial height) measured spanwise along the respective span line 50 from the inner platform surface 52 to the fan blade tip 54. This spanwise height 56 of FIGS. 2A and 2B is measured at a height reference location 58 disposed at an intermediate location (e.g., a midpoint) between a leading edge plane 60 and a trailing edge plane 62. The leading edge plane 60 is a reference plane perpendicular to the propulsion system axis 26 at respective leading edges 64 of the fan blades 48, for example at an intermediate span position between the inner platform surface 52 and the fan blade tips 54. The trailing edge plane 62 is a reference plane perpendicular to the propulsion system axis 26 at respective trailing edges 66 of the fan blades 48, for example at an intermediate span position between the inner platform surface 52 and the fan blade tips 54. The present disclosure, however, is not limited to such an exemplary reference basis for measuring the spanwise height 56. For example, the height reference location 58 may alternatively be disposed along the leading edge plane 60 or the trailing edge plane 62.

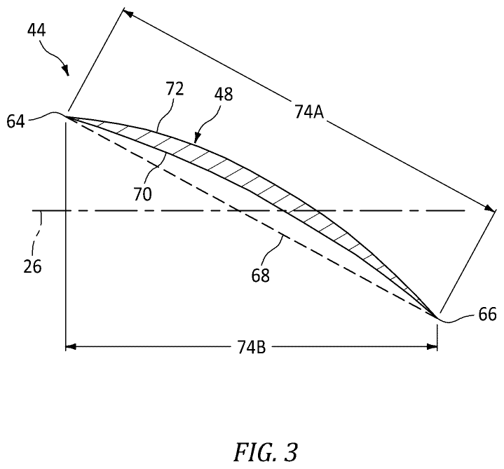

Referring to FIG. 3, each fan blade 48 extends chordwise along a chord line 68 of the respective fan blade 48 from its blade leading edge 64 to its blade trailing edge 66. Each fan blade 48 extends widthwise between a first side 70 (e.g., a concave, pressure side) of the respective fan blade 48 and a second side 72 (e.g., a convex, suction side) of the respective fan blade 48. The first side 70 and the second side 72 extends chordwise between and meet at the respective blade leading edge 64 and the respective blade trailing edge 66. Each fan blade 48 has a chord length 74A, 74B (generally referred to as “74”) measured between the respective blade leading edge 64 and the respective blade trailing edge 66. This chord length 74A may be a true chord length, where the chord length 74A is measured along the chord line 68 between the respective blade leading edge 64 and the respective blade trailing edge 66. Alternatively, the chord length 74B may be an axial chord length, where the chord length 74B is measured along the propulsion system axis 26 between the respective blade leading edge 64 and the respective blade trailing edge 66. For ease of description, referring to FIGS. 2A and 2B, the chord length 74 may be measured between the respective blade leading edge 64 and the respective blade trailing edge 66 at a spanwise location where the chord length 74 has its greatest value. The chord length 74 may thereby be a maximum chord length of the respective fan blade 48.

Referring to FIG. 1, the LPC section 33A includes a bladed low pressure compressor (LPC) rotor 76. The HPC section 33B includes a bladed high pressure compressor (HPC) rotor 77. The HPT section 35A includes a bladed high pressure turbine (HPT) rotor 78. The LPT section 35B includes a bladed low pressure turbine (LPT) rotor 79. Each of these engine rotors 76-79 includes a rotor base (e.g., a disk or a hub) and a plurality of rotor blades (e.g., airfoils, vanes, etc.). The rotor blades may be arranged into one or more stages axially along the respective engine rotor 76-79 and longitudinally along the core flowpath 40. The rotor blades in each stage are arranged and may be equispaced circumferentially around the respective rotor base in an annular array. Each of the rotor blades is connected to (e.g., formed integral with or otherwise attached to) the respective rotor base. Each of the rotor blades projects spanwise (e.g., radially) out from the respective rotor base, substantially across the core flowpath 40, to a distal tip of the respective rotor blade.

The HPC rotor 77 is coupled to and rotatable with the HPT rotor 78. The HPC rotor 77 of FIG. 1, for example, is connected to the HPT rotor 78 through a high speed shaft 82. At least (or only) the HPC rotor 77, the HPT rotor 78 and the high speed shaft 82 collectively form a high speed rotating structure 84. This high speed rotating structure 84 of FIG. 1 and its members 77, 78 and 82 are rotatable about the propulsion system axis 26. However, it is contemplated the high speed rotating structure 84 may alternatively be rotatable about another axis laterally and/or angularly offset from the rotational axis of the fan rotor 44 and/or the centerline axis of the turbine engine 22.

The fan rotor 44 and/or the LPC rotor 76 are coupled to and rotatable with the LPT rotor 79. The LPC rotor 76 of FIG. 1, for example, is connected to the fan rotor 44. The fan rotor 44 of FIG. 1 is connected to the LPT rotor 79 through a low speed shaft 86. The LPC rotor 76 of FIG. 1 is thereby coupled to the LPT rotor 79 through the fan rotor 44 and the low speed shaft 86. At least (or only) the fan rotor 44, the LPC rotor 76, the LPT rotor 79 and the low speed shaft 86 collectively form a low speed rotating structure 88. This low speed rotating structure 88 of FIG. 1 and its members 44, 76, 79 and 86 are rotatable about the propulsion system axis 26. The present disclosure, however, is not limited to such an exemplary rotating structure arrangement. For example, it is contemplated the LPC rotor 76 may alternatively be connected to the low speed shaft 86 independent of the fan rotor 44. In addition or alternatively, it is contemplated the fan rotor 44 and/or the LPC rotor 76 may be coupled to the low speed shaft 86 through a geartrain; e.g., a transmission, a speed change device, an epicyclic geartrain, etc.

The core flowpath 40 extends sequentially through the LPC section 33A, the HPC section 33B, the combustor section 34, the HPT section 35A and the LPT section 35B from an airflow inlet 90 into the core flowpath 40 to a combustion products exhaust 92 out from the core flowpath 40. The bypass flowpath 42 extends through a bypass duct from an airflow inlet 94 into the bypass flowpath 42 to an airflow exhaust 96 from the bypass flowpath 42. The bypass flowpath 42 and its bypass duct are configured to bypass (e.g., are disposed radially outboard of and extend along) the engine core 38. The core inlet 90 and the bypass inlet 94 are axially aligned along the propulsion system axis 26. The core inlet 90 and the bypass inlet 94 of FIG. 1 are also arranged axially next to and downstream of the fan rotor 44 and its fan blades 48. The core inlet 90 and the bypass inlet 94 may thereby be arranged downstream of the fan rotor 44 and its fan blades 48, without (e.g., any) other elements axially therebetween to obstruct, turn and/or otherwise influence the air propelled by the fan rotor 44 into the core inlet 90 and the bypass inlet 94 for example.

The fan section 32, the LPC section 33A, the HPC section 33B, the combustor section 34, the HPT section 35A and the LPT section 35B may be arranged sequentially along the propulsion system axis 26 within the housing structure 24. The housing structure 24 of FIG. 1, for example, includes an inner housing structure 98 and an outer housing structure 100. The housing structure 24 may also include a guide vane structure 102; e.g., a fan exit guide vane (FEGV) structure.

The inner housing structure 98 of FIG. 1 includes an inner case 104 (e.g., a core case) for the turbine engine 22 and an inner nacelle structure 106 (sometimes referred to as an inner fixed structure (IFS)). The inner case 104 is disposed radially outboard of, extends axially along and may circumscribe one or more or all of the engine sections 33A-35B and the engine rotors 76-79. The inner case 104 may thereby house and provide a support structure for the respective engine sections 33A-35B and the engine rotors 76-79. The inner nacelle structure 106 is configured to provide an aerodynamic cover over the engine core 38 and its inner case 104. The inner housing structure 98 and its inner nacelle structure 106 may also form a radial inner peripheral boundary of the bypass flowpath 42.

The outer housing structure 100 of FIG. 1 includes an outer case 108 (e.g., a fan case) for the turbine engine 22 and an outer nacelle structure 110. The outer case 108 is disposed radially outboard of, extends axially along and may circumscribe the fan section 32 and its fan rotor 44. The outer case 108 may thereby house and may be configured as a containment structure for the fan section 32 and its fan rotor 44. The outer nacelle structure 110 is configured to provide an aerodynamic cover over the outer case 108. The outer housing structure 100 and its outer nacelle structure 110 may also form a radial outer peripheral boundary of the bypass flowpath 42.

The guide vane structure 102 includes a plurality of guide vanes 112. These guide vanes 112 are arranged and may be equispaced circumferentially around the inner housing structure 98 and the propulsion system axis 26 in an array; e.g., an annular array. The guide vanes 112 are disposed within the bypass flowpath 42. Each guide vane 112 of FIG. 1, for example, projects radially across the bypass flowpath 42 from the inner housing structure 98 to the outer housing structure 100. The guide vanes 112 may also be connected to the inner housing structure 98 and the outer housing structure 100 to structurally tie the inner housing structure 98 and the outer housing structure 100 together.

During operation of the aircraft propulsion system 20 of FIG. 1, ambient air from an environment 114 external to the aircraft and its aircraft propulsion system 20 enters the aircraft propulsion system 20 and its turbine engine 22 through an airflow inlet 116. This air is propelled by the rotating fan rotor 44 in a downstream, aft direction towards the propulsion system aft end 30.

An outer stream of the air propelled by the rotating fan rotor 44 is directed into the bypass flowpath 42 through its bypass inlet 94, which air entering the bypass flowpath 42 may be referred to as “bypass air”. The guide vane structure 102 conditions (e.g., straightens out, de-swirls, etc.) the flow of the bypass air within the bypass duct. This conditioned bypass air is subsequently directed out of the aircraft propulsion system 20 through the bypass exhaust 96 to provide forward thrust. This propulsion of the bypass air may account for a majority of the forward thrust generated by the aircraft propulsion system 20 and its turbine engine 22 of FIG. 1.

An inner stream of the air propelled by the rotating fan rotor 44 is directed into the core flowpath 40 through its core inlet 90, which air entering the core flowpath 40 may be referred to as “core air”. This core air is compressed by the LPC rotor 76 and the HPC rotor 77 and is directed into a combustion chamber 118 (e.g., annular combustion chamber) of a combustor 120 (e.g., annular combustor) in the combustor section 34. Fuel is injected into the combustion chamber 118 by one or more fuel injectors and mixed with the compressed core air to provide a fuel-air mixture. This fuel-air mixture is ignited and combustion products thereof flow through and sequentially drive rotation of the HPT rotor 78 and the LPT rotor 79. The rotation of the HPT rotor 78 and the LPT rotor 79 respectively drive rotation of the HPC rotor 77 and the LPC rotor 76 and, thus, compression of the air received from the core inlet 90. The rotation of the LPT rotor 79 also drives rotation of the fan rotor 44.

Referring to FIGS. 2A and 2B, the inner housing structure 98 includes an inter-flowpath structure 122 radially between the core flowpath 40 and the bypass flowpath 42, next to and downstream of the fan rotor 44. This inter-flowpath structure 122 includes a radial inner wall 124, a radial outer wall 126 and an airflow splitter 128.

The inner wall 124 extends axially along the propulsion system axis 26 to an upstream, forward end of the inner wall 124. The inner wall 124 extends circumferentially about (e.g., completely around) the propulsion system axis 26. The inner wall 124 may thereby have a full-hoop (e.g., tubular) geometry. A radial inner side of the inner wall 124 forms a radial outer peripheral boundary of the core flowpath 40, downstream and aft of an exposed inner surface 130 of the airflow splitter 128.

The outer wall 126 is spaced radially outboard from the inner wall 124. The outer wall 126 extends axially along the propulsion system axis 26 to an upstream, forward end of the outer wall 126. The outer wall 126 extends circumferentially about (e.g., completely around) the propulsion system axis 26. The outer wall 126 may thereby have a full-hoop (e.g., tubular) geometry. This outer wall 126 of FIG. 2 also extends axially along (e.g., axially overlaps) and extends circumferentially about (e.g., circumscribes) the inner wall 124 and the airflow splitter 128. A radial outer side of the outer wall 126 forms a radial inner peripheral boundary of the bypass flowpath 42, downstream and aft of an exposed outer surface 132 of the airflow splitter 128 and upstream and forward of the guide vane structure 102.

The airflow splitter 128 is a wedge-shaped member of the inter-flowpath structure 122 configured to split the air propelled by the rotating fan rotor 44 into the outer stream directed into the bypass flowpath 42 and the inner stream directed into the core flowpath 40. A downstream, aft portion of the airflow splitter 128 is arranged radially between the inner wall 124 and the outer wall 126. An upstream, forward portion of the airflow splitter 128 projects axially along the propulsion system axis 26 (away from the inner wall 124 and the outer wall 126) to an upstream, forward leading edge 134 of the airflow splitter 128. This splitter leading edge 134 is also an upstream, forward leading edge of the inter-flowpath structure 122. The airflow splitter 128 extends radially between the splitter inner surface 130 and the splitter outer surface 132, where these splitter surfaces 130 and 132 extends axially to and meet at the splitter leading edge 134. The airflow splitter 128 and its splitter surfaces 130 and 132 extend circumferentially about (e.g., completely around) the propulsion system axis 26. The airflow splitter 128 may thereby have a full-hoop (e.g., annular) geometry. With the arrangement of FIGS. 2A and 2B, the airflow splitter 128 provides an intersection between the inner wall 124 and the outer wall 126. More particularly, the airflow splitter 128 provides an intersection between the outer peripheral boundary of the core flowpath 40 and the inner peripheral boundary of the bypass flowpath 42 at the splitter leading edge 134. A radial split line of the airflow between the core inlet 90 and the bypass inlet 94 extends forward from the intersection to the airflow inlet 116. The splitter inner surface 130 of FIGS. 2A and 2B forms a radial outer peripheral boundary of the core inlet 90 at the splitter leading edge 134. Similarly, the splitter outer surface 132 of FIGS. 2A and 2B forms a radial inner peripheral boundary of the bypass inlet 94 at the splitter leading edge 134. The airflow splitter 128 may alter the relative radial split line position between the core inlet 90 and the bypass inlet 94 to increase a core inlet area relative to a bypass inlet area.

The airflow splitter 128 and its splitter leading edge 134 are radially aligned with a reference point 136 along each fan blade 48. This reference point 136 is disposed a spanwise distance 138 from the inner platform surface 52 along the respective span line 50. The spanwise distance 138 is between one-tenth ( 1/10) of the spanwise height 56 and one-half (½) of the spanwise height 56. More particularly, the spanwise distance 138 may be equal to or greater than two-tenths ( 2/10) or even three-tenths ( 3/10) of the spanwise height 56. The airflow splitter 128 and its splitter leading edge 134 are thereby radially aligned with an intermediation portion of each fan blade 48 along its span. The reference point 136 of FIGS. 2A and 2B is axially aligned along the propulsion system axis 26 with an intermediate location along the respective fan blade 48 between its blade leading edge 64 and its blade trailing edge 66, such as the height reference location 58. However, it is contemplated the reference point 136 may alternatively be on the leading edge plane 60 or the trailing edge plane 62.

The airflow splitter 128 is mechanically coupled to an actuation system 140. This actuation system 140 is configured to move (e.g., translate) the airflow splitter 128 between a retracted position (e.g., see FIG. 2A) and an extended position (e.g., see FIG. 2B). The actuation system 140 may (or may not) also be configured to move the airflow splitter 128 to one or more intermediate positions axially between the retracted position of FIG. 2A and the extended position of FIG. 2B. The actuation system 140, for example, may include an actuator 142 (or multiple actuators) between and operatively coupled to the aft portion of the airflow splitter 128 and a stationary portion of the inner housing structure 98. Examples of the actuator 142 include, but are not limited to, a linear actuator such as a hydraulic piston, or a lead screw operably coupled to a drive motor such as a pneumatic motor or an electric motor.

In the retracted position of FIG. 2A, the splitter leading edge 134 is disposed an axial retracted position distance 144A along the propulsion system axis 26 from the blade trailing edges 66 of the fan blades 48. This retracted position distance 144A may be equal to or less than one and one-half times (1.5×) the chord length 74. More particularly, the retracted position distance 144A may be equal to or less than one time (1×) the chord length 74 or three-fourths (¾) of the chord length 74. Thus, even when the airflow splitter 128 is retracted, the splitter leading edge 134 may still be in close axial proximity to the fan rotor 44 and its fan blades 48.

In the extended position of FIG. 2B, the splitter leading edge 134 is disposed an axial extended position distance 144B along the propulsion system axis 26 from the blade trailing edges 66 of the fan blades 48. This extended position distance 144B is less than the retracted position distance 144A. However, the extended position distance 144B may be equal to or greater than one-tenth ( 1/10) of the retracted position distance 144A, one-fourth (¼) of the retracted position distance 144A or one-third (⅓) of the retracted position distance 144A (see FIG. 2A).

By moving (e.g., translating) the airflow splitter 128 axially along the propulsion system axis 26 between the retracted position of FIG. 2A and the extended position of FIG. 2B, or anywhere axially therebetween, the airflow splitter 128 may influence a relative radial split line position between the core inlet 90 and the bypass inlet 94. For example, an inner flowpath wall 146 extending axially between the core inlet 90 and the fan rotor 44 and its inner platform surface 52 may taper radially inwards towards the propulsion system axis 26 as that inner flowpath wall 146 extends axially from the core inlet 90 towards the fan rotor 44. With this arrangement, as the airflow splitter 128 moves axially towards its extended position of FIG. 2B, a radial distance between the inner flowpath wall 146 and the airflow splitter 128 and its splitter leading edge 134 increases. By increasing this radial distance, the airflow splitter 128 may alter the relative radial split line position between the core inlet 90 and the bypass inlet 94 to increase a core inlet area relative to a bypass inlet area. The radial split line position may be radially outward relative to the reference point 136 or radially inward relative to the reference point 136. The actuation system 140 may thereby be controlled to facilitate an optimized radial location of the relative radial split line position based on, for example, an operating mode in which the turbine engine 22 is operating and/or one or more other operational parameters.

The airflow splitter 128 may also or alternatively be moved along the propulsion system axis 26 to shed ice at the core inlet 90 and/or the bypass inlet 94. For example, the actuation system 140 may (e.g., slightly) periodically or continuously move the airflow splitter 128 along the propulsion system axis 26. The relative movement between the airflow splitter 128 and the inner wall 124 and/or the outer wall 126 may shed ice from the airflow splitter 128.

The actuation system 140 is operationally controlled by a controller 148. The controller 148 may be configured as an onboard engine controller; e.g., an electronic engine controller (EEC), an electronic control unit (ECU), a full-authority digital engine controller (FADEC), etc. The controller 148 may be implemented with a combination of hardware and software. The hardware may include memory 150 and at least one processing device 152, which processing device 152 may include one or more single-core and/or multi-core processors. The hardware may also or alternatively include analog and/or digital circuitry other than that described above.

The memory 150 is configured to store software (e.g., program instructions) for execution by the processing device 152, which software execution may control and/or facilitate performance of one or more operations such as those described herein. The memory 150 may be a non-transitory computer readable medium. For example, the memory 150 may be configured as or include a volatile memory and/or a nonvolatile memory. Examples of a volatile memory may include a random access memory (RAM) such as a dynamic random access memory (DRAM), a static random access memory (SRAM), a synchronous dynamic random access memory (SDRAM), a video random access memory (VRAM), etc. Examples of a nonvolatile memory may include a read only memory (ROM), an electrically erasable programmable read-only memory (EEPROM), a computer hard drive, etc.

To facilitate ice shedding from the airflow splitter 128, the controller 148 may signal the actuation system 140 to initiate the movement (e.g., translation) of the airflow splitter 128 based on one or more parameters. For example, as a temperature of the ambient air ingested into the aircraft propulsion system 20 through the airflow inlet 116 decreases, there is a higher chance for ice accumulation on the airflow splitter 128. Therefore, where the ambient air temperature is equal to or less than a threshold, the controller 148 may signal the actuation system 140 to start periodically or continuously moving the airflow splitter 128 back and forth along the propulsion system axis 26. In addition, as a rotational speed of the fan rotor 44 decreases, there is higher chance for ice accumulation on the airflow splitter 128. Therefore, where the rotational speed of the fan rotor 44 is equal to or less than a threshold, the controller 148 may signal the actuation system 140 to start periodically or continuously moving the airflow splitter 128 back and forth along the propulsion system axis 26. The present disclosure, however, is not limited to the foregoing control methodologies for initiating ice shedding movement of the airflow splitter 128.

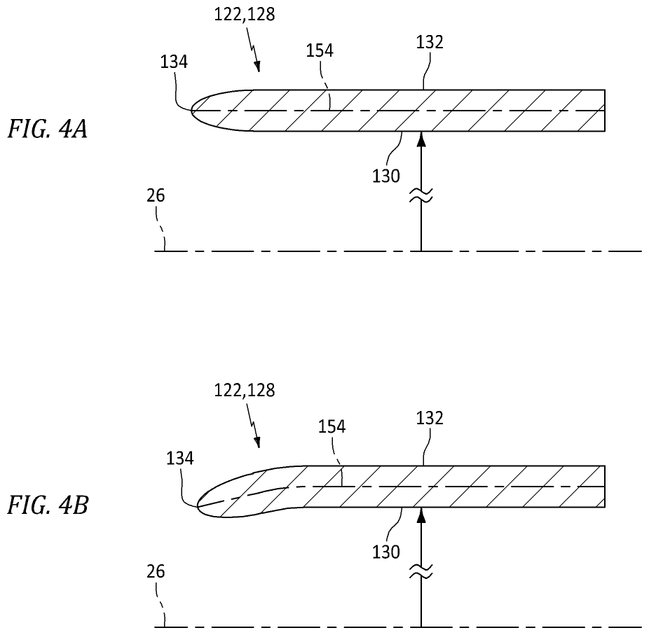

In some embodiments, referring to FIG. 4A, a body centerline 154 of the airflow splitter 128 between the splitter inner surface 130 and the splitter outer surface 132 may follow a straight-line trajectory to the splitter leading edge 134. In other embodiments, referring to FIG. 4B, the body centerline 154 may follow a non-straight-line trajectory to the splitter leading edge 134. The body centerline 154 of FIG. 4B and, more generally, the airflow splitter 128 may turn (e.g., slightly) radially inward towards the propulsion system axis 26 as a tip portion of the airflow splitter 128 projects axially to the splitter leading edge 134.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An assembly for an aircraft propulsion system, comprising:
a fan rotor comprising a platform surface and a plurality of fan blades arranged circumferentially about an axis, the plurality of fan blades comprising a first fan blade, the first fan blade comprising a first chord length and a spanwise height that extends spanwise along a span line of the first fan blade from the platform surface to a tip of the first fan blade;
an inner flowpath comprising an inner flowpath inlet downstream of the fan rotor;
an outer flowpath comprising an outer flowpath inlet downstream of the fan rotor, the outer flowpath inlet radially outboard of the inner flowpath inlet; and
an inter-flowpath structure disposed radially between and partially forming the inner flowpath inlet and the outer flowpath inlet, the inter-flowpath structure comprising a splitter and an actuator, the splitter forming a leading edge of the inter-flowpath structure, the actuator configured to translate the splitter axially along the axis between a first position and a second position, the leading edge of the inter-flowpath structure disposed a first distance along the axis from the first fan blade when the splitter is in the first position, the leading edge of the inter-flowpath structure disposed a second distance along the axis from the first fan blade when the splitter is in the second position, the second distance greater than the first distance, and the second distance equal to or less than one and one-half times the first chord length;
wherein a reference point is disposed a spanwise distance from the platform surface along the span line, the spanwise distance is equal to or greater than one-tenth of the spanwise height, and the reference point is radially aligned with the leading edge of the inter-flowpath structure.

2. The assembly of claim 1, wherein the second distance is equal to or less than the first chord length.

3. The assembly of claim 1, wherein the second distance is equal to or less than three-fourths of the first chord length.

4. The assembly of claim 1, wherein the first distance is equal to or greater than one-fourth of the second distance.

5. The assembly of claim 1, wherein the first distance is equal to or greater than one-third of the second distance.

6. The assembly of claim 1, wherein the splitter extends circumferentially about the axis.

7. The assembly of claim 1, wherein the splitter comprises an annular splitter.

8. (canceled)

9. The assembly of claim 1, wherein the spanwise distance is equal to or greater than two-tenths of the spanwise height.

10. The assembly of claim 1, wherein the spanwise distance is equal to or less than one-half of the spanwise height.

11. The assembly of claim 1, further comprising a controller configured to control operation of the actuator to translate the splitter when a rotational speed of the fan rotor is equal to or less than a threshold.

12. The assembly of claim 1, further comprising a controller configured to control operation of the actuator to translate the splitter when an air temperature is equal to or less than a threshold.

13. The assembly of claim 1, further comprising:
an engine core comprising a compressor section, a combustor section and a turbine section, the inner flowpath extending through the compressor section, the combustor section and the turbine section from the inner flowpath inlet to an inner flowpath exhaust;
the outer flowpath bypassing the engine core.

14. The assembly of claim 13, further comprising:
a bladed turbine rotor disposed in the turbine section;
the bladed turbine rotor operably coupled to and configured to drive rotation of the fan rotor about the axis.

15. The assembly of claim 13, further comprising:
a compressor rotor coupled to and rotatable with the fan rotor;
the inner flowpath extending across the compressor rotor.

16. An assembly for an aircraft propulsion system, comprising:
a fan rotor comprising a platform surface and a plurality of fan blades arranged circumferentially about an axis, the plurality of fan blades comprising a first fan blade, and the first fan blade comprising a spanwise height that extends spanwise along a span line of the first fan blade from the platform surface to a tip of the first fan blade, wherein a reference point is disposed a spanwise distance from the platform surface along the span line, and the spanwise distance is equal to or greater than one-tenth of the spanwise height;
an inner flowpath comprising an inner flowpath inlet next to and downstream of the fan rotor;
an outer flowpath comprising an outer flowpath inlet next to and downstream of the fan rotor, the outer flowpath inlet radially outboard of the inner flowpath inlet; and
an inter-flowpath structure disposed radially between and partially forming the inner flowpath inlet and the outer flowpath inlet, the inter-flowpath structure comprising a splitter and an actuator, the splitter forming a leading edge of the inter-flowpath structure that is radially aligned with the reference point, the actuator configured to move the splitter axially along the axis between a first position and a second position, the leading edge of the inter-flowpath structure disposed a first distance along the axis from the first fan blade when the splitter is in the first position, the leading edge of the inter-flowpath structure disposed a second distance along the axis from the first fan blade when the splitter is in the second position, and the second distance greater than the first distance;
wherein the first fan blade comprises a first chord length, and the second distance is equal to or less than one and one-half times the first chord length.

17. The assembly of claim 16, wherein the spanwise distance is between two-tenths of the spanwise height and one-half of the spanwise height.

18. The assembly of claim 16, further comprising a controller configured to control operation of the actuator to periodically and/or continuously move the splitter back and forth along the axis based on a rotational speed of the fan rotor.

19. The assembly of claim 16, further comprising a controller configured to control operation of the actuator to periodically and/or continuously move the splitter back and forth along the axis based on an air temperature.

20. An assembly for an aircraft propulsion system, comprising:
a fan rotor comprising a plurality of fan blades arranged circumferentially about an axis, the plurality of fan blades comprising a first fan blade;
an inner flowpath comprising an inner flowpath inlet next to and downstream of the fan rotor;
an outer flowpath comprising an outer flowpath inlet next to and downstream of the fan rotor, the outer flowpath inlet radially outboard of the inner flowpath inlet;
an inter-flowpath structure disposed radially between and partially forming the inner flowpath inlet and the outer flowpath inlet, the inter-flowpath structure comprising a splitter and an actuator, the splitter forming a leading edge of the inter-flowpath structure, the actuator configured to move the splitter axially along the axis between a first position and a second position, the leading edge of the inter-flowpath structure disposed a first distance along the axis from the first fan blade when the splitter is in the first position, the leading edge of the inter-flowpath structure disposed a second distance along the axis from the first fan blade when the splitter is in the second position, and the second distance greater than the first distance; and
a controller configured to facilitate ice shedding of the splitter by controlling operation of the actuator to move the splitter back and forth along the axis based on at least one of a rotational speed of the fan rotor or an air temperature;
wherein the first fan blade includes a first chord length, and the second distance is equal to or less than one and one-half times the first chord length.
